(19) United States
(12) Patent Application Publication
(10) Pub. No.: US 2024/0342720 A1
(43) Pub. Date: Oct. 17, 2024

(54) IMPROVEMENTS IN OR RELATING TO IMAGING MICRODROPLETS IN A MICROFLUIDIC DEVICE

(71) Applicant: LIGHTCAST DISCOVERY LTD, Cambridge, Cambridgeshire (GB)

(72) Inventors: Thomas Henry ISAAC, Cambridge, Cambridgeshire (GB); William Michael DEACON, Cambridge, Cambridgeshire (GB); Jasmin Kaur Chana CONTERIO, Cambridge, Cambridgeshire (GB)

(73) Assignee: LIGHTCAST DISCOVERY LTD, Cambridge, Cambridgeshire (GB)

(21) Appl. No.: 18/577,431

(22) PCT Filed: Jul. 8, 2022
(86) PCT No.: PCT/GB2022/051766

§ 371 Date: Jan. 8, 2024

(30) Foreign Application Priority Data
Jul. 9, 2021 (GB) 2109967.6

(51) Int. Cl. B01L 3/00

(52) U.S. Cl. CPC B01L 3/502784; B01L 3/502715; B01L 2300/0654; B01L 2400/0427

(57) ABSTRACT

An apparatus comprising a microfluidic device comprising a microfluidic space configured to contain a plurality of microdroplets; a first light source for illuminating the microfluidic device; a voltage source for supplying a voltage to the microfluidic device in order to generate an electric field across the microfluidic space; a first modulator configured to generate a waveform signal to modulate the electric field applied across the microfluidic space, wherein the first modulator is configured to switch between an active state, in which the electric field is applied across the microfluidic space to hold the plurality of microdroplets; and a non-active state, in which the electric field is not applied across the microfluidic space; and an optical imaging device for generating an image of at least a subset of the microdroplets; wherein the first modulator is further configured to, directly or indirectly, control the first light source such that at least a portion of the light is provided across the microfluidic device during the active state; and wherein the first modulator is further configured to control the optical imaging device such that the image of at least a subset of the microdroplets is generated during the non-active state.

### FIELD OF THE INVENTION

The present disclosure relates to an apparatus for imaging microdroplets in a microfluidic device, and in particular, to an apparatus for maintaining microdroplet control whilst imaging microdroplets in an opto-electronic microfluidic device.

### BACKGROUND TO THE INVENTION

Droplet-based microfluidic systems aim quickly to perform large numbers of reactions in parallel using low reagent volumes. Droplets within a microfluidic device can be controlled with different techniques including using the Electrowetting-on-dielectric (EWOD) effect; a well-known effect in which an electric field applied between a liquid and a substrate makes the liquid more wetting on the surface than the natural state.

Optical-based droplet manipulation technologies can enable light to be patterned and reconfigured to provide dynamic control over microdroplets without using complex control circuitry within the device. Optically mediated electrowetting-on-dielectric (oEWOD) devices involve microdroplets being translocated through a microfluidic space defined by containing walls; for example a pair of parallel plates having the microfluidic space sandwiched therebetween. At least one of the containing walls includes what are hereinafter referred to as ‘virtual’ electrowetting electrodes locations which are generated by selectively illuminating an area of a semiconductor layer buried within. By selective illumination of the layer with light from a separate light source, controlled by an optical assembly, a virtual pathway of virtual electrowetting electrode locations can be generated transiently along which the microdroplets can be caused to move. Thus conductive cells are dispensed with and permanent droplet-receiving locations are abandoned in favour of a homogeneous dielectric surface on which the droplet-receiving locations are generated ephemerally by selective and varying illumination of points on the photoconductive layer using, for example, a pixelated light source. This enables highly localised electrowetting fields capable of moving the microdroplets on the surface by induced capillary-type forces to be established anywhere on the dielectric layer; optionally in association with any directional microfluidic flow of the carrier medium in which the microdroplets are dispersed; for example by emulsification. In other words, the carrier medium contains the microdroplets.

Optical-based droplet manipulation techniques, such as oEWOD, have the potential to provide a flexible and high throughput droplet manipulation platform. A challenge arises in integrating a suitable detection technique for imaging and taking measurements on microdroplets within the microfluidic space. Light based measurements such as fluorescence measurements are a crucial tool for performing biological assays. However, the light required to image and measure microdroplets can cause a loss of microdroplet control by overwhelming with the light used to hold or manipulate the microdroplets. When not controlled or immobilised, microdroplets tend to drift within the microfluidic platform, which can further complicate acquiring high quality images or measurements.

There is therefore a requirement for an invention which can precisely control microdroplets using an optical-based droplet manipulation technique within a microfluidic device, and which can acquire images and/or optical measurements without resulting in a loss of microdroplet control.

It is against this background that the present invention has arisen.

### SUMMARY OF THE INVENTION

According to an aspect of the present invention, there is provided an apparatus comprising: a microfluidic device comprising: a microfluidic space configured to contain a plurality of microdroplets; a first light source for illuminating the microfluidic device; a voltage source for supplying a voltage to the microfluidic device in order to generate an electric field across the microfluidic space; a first modulator provided to generate a waveform signal to modulate the electric field applied across the microfluidic space, wherein the first modulator is provided to switch between an active state, in which the electric field is applied across the microfluidic space; and a non-active state, in which the electric field is not applied across the microfluidic space; and wherein the first modulator is further provided to, directly or indirectly, control the first light source such that at least a portion of the light is provided across the microfluidic device during the active state to hold the plurality of microdroplets in the presence of the electric field; an optical imaging device for generating an image of at least a subset of the microdroplets; and wherein the first modulator is further configured to control the optical imaging device such that the image of at least a subset of the microdroplets is generated during the non-active state.

The first modulator, which provides the waveform to modulate the electric field, provides a modulation at the switching frequency of the system. In other words, it provides a modulation of the field that fulfils the optoelectronic requirements of the system in relation to the switching between the active and non-active state. In some embodiments, this may be at 50 Hz. This is quite distinct from the A/C frequency of the electric field, which may be, for example, 1 kHz.

According to another aspect of the present invention, there is provided an apparatus comprising a microfluidic device comprising: a microfluidic space configured to contain a plurality of microdroplets; a first light source for illuminating the microfluidic device; a voltage source for supplying a voltage to the microfluidic device in order to generate an electric field across the microfluidic space; a first modulator configured to generate a waveform signal to modulate the electric field applied across the microfluidic space, wherein the first modulator is configured to switch between an active state, in which the electric field is applied across the microfluidic space to hold the plurality of microdroplets; and a non-active state, in which the electric field is not applied across the microfluidic space; and an optical imaging device for generating an image of at least a subset of the microdroplets; wherein the first modulator is further configured to, directly or indirectly, control the first light source such that at least a portion of the light is provided across the microfluidic device during the active state; and wherein the first modulator is further configured to control the optical imaging device such that the image of at least a subset of the microdroplets is generated during the non-active state.

The device according to the present invention can be a microfluidic device, such as an opto-electronic microfluidic device. The device of the present invention enables a user to apply an electric field to the microfluidic space in order to hold at least a subset of microdroplets in position. The application of the electric field can be advantageous because it enables the microdroplets to be held in an array within the microfluidic space. The electric field can be an A/C field.

In addition, the microdroplet, or at least a subset of microdroplets, can be manipulated and/or controlled within the microfluidic space by providing a light source that provides light which is suitable for performing droplet manipulation to the microdroplets, for example through oEWOD, during the active state. In some embodiments, the holding light source may be used to manipulate the microdroplets, for example to merge or split the microdroplets using oEWOD.

In embodiments where two light sources are provided, droplet control can be maintained with the first light source, which provides the droplet manipulation and holding illumination, on at all times. There is no droplet holding requirement for this light source during the non-active state and therefore it may remain on. In these cases, when the light is recollected from the sample, the light from the first light source can be filtered out prior to imaging or removed computationally from recorded images. Alternatively, the first light source can be switched off during the non-active state, in some cases this removes the filtering requirement but in other approaches the requirement remains. This is a contrast to the requirements on the imaging light source in a two light source system. For the imaging light source, there is a requirement for the light source to be switched on and off in opposite phase to the electric field. For the avoidance of doubt, the filtering can be achieved via one or more of a shutter, colour filter or polarisation.

The light from the light source can provide a ‘holding illumination’ that is suitable for oEWOD for manipulating microdroplets. In some embodiments, the light from the light source can provide an imaging illumination that can be used for imaging, for example, fluorescence measurements.

The term ‘holding illumination’ as used within the context of this invention, should be understood to include any illumination used in combination with the electric field to hold, manipulate and/or control at least a subset of the microdroplets during the active state. Hence, for oEWOD operations, light for illumination and the electric field is required. Microdroplet manipulation may include, but is not limited to operations to sort, merge, split, and/or arrange microdroplets for example into an array.

A subset of microdroplets, as disclosed herein, can include one or more microdroplets.

The first modulator is further configured to, directly or indirectly, control the first light source such that at least a portion of the light is provided across the microfluidic space during the active state. Directly controlling the first light source can include the first modulator being configured to switch the light source between on and off states. Indirectly controlling the first light source can include the use of a filter, which can in turn be controlled by a controller or a first modulator and/or a second modulator. The filter, which can include a spatial filter, can operate on the first light source such that a portion of the light suitable for holding and/or manipulating the microdroplets is provided across the microfluidic space during the active state.

In some embodiments, the filter may be a colour filter. The colour filter can switch between different colours during the operation of the apparatus according to the present invention. The colour filters may be deployed with one light source or it May be deployed with two light sources, where the colour filters can be exchanged. Typically, the colour filter is not modulated by the modulator. In embodiments where two light sources are deployed, if colour filtration is deployed in the imaging pathway, then the oEWOD light source can remain active throughout without affecting the imaging light.

In some embodiments, the filter may be a spatial filter such as DMD. The spatial filter is modulated by the first or second modulators. When a single light source is used, the spatial filter has several oscillation modes and can oscillate at multiple different frequencies.

In some embodiments, the first modulator may be further configured to control the optical imaging device to generate an image of at least a subset of microdroplets during the non-active state.

In some embodiments, the first modulator is further configured to control, directly or indirectly, the first light source such that the first light source provides an imaging illumination for imaging of the microdroplet, or at least a subset of the microdroplets, during the non-active state. In some embodiments, the first modulator may be further configured to control, directly or indirectly, the first light source such that the first light source provides light suitable for fluorescence to at least a subset of the microdroplets during the non-active state.

In some embodiments, the image may be a fluorescence image, or a fluorescence resonance energy transfer image, or a brightfield image, or a chemiluminescence image. The image may be a single image captured during a single switching non-active state interval. However, in some embodiments the image may be integrated across a 0.25 s, 0.5 s or 1 s time interval. Therefore, if the first modulator is applying a switching modulation to the A/C field at 50 Hz, then the 1 s time integration will include light collected from 50 modulation cycles. This integration approach allows the impact of read noise to be minimised and a greater signal-to-noise to be achieved. This is important for many imaging techniques such as fluorescence.

In some embodiments, the controller, first modulator and/or the second modulator may be further configured to control a filter in order for the light applied to at least a subset of the microdroplets during the non-active state to be suitable for imaging. In some embodiments, the filter may be configured to filter at least a portion of the light from the first light source such that the microfluidic space is illuminated with different wavelengths of light during the active and non-active states. In some embodiments, the filter may be a colour filter.

The filter enables a single light source to be used for both holding illumination and imaging illumination during the active and non-active states which can be beneficial as it is simple and efficient for the user to operate as well as being cost-effective. In the case where a single light source is used for holding the microdroplets and imaging at least a subset of the microdroplets, the single light source is spatially modulated.

In some embodiments, especially in a single light source configuration, the first light source is on continuously during the active and non-active state. The filter can operate on the first light source to switch between a holding pattern and an imaging illumination pattern.

In some embodiments, the first modulator may be further configured to control, directly or indirectly, the first light source such that the first light source does not provide light to at least a subset of the microdroplets during the non-active state. In some embodiments, the controller may control a filter such that no light is provided to the microdroplets during the non-active state. In some embodiments, the first modulator may control the first light source such that it is in an ‘off’ state during the non-active state. This can be advantageous when the optical imaging device is configured to generate a chemiluminescence image, for example. In some embodiments, the first light source may be a dual wavelength light source, and controlling the optical imaging device to generate an image of at least a subset of the microdroplets may include switching from a wavelength suitable for holding the microdroplet, to a different specific wavelength that is suitable for imaging. By switching between different wavelengths for the manipulating and imaging illuminations, there is a spectral distinction which can facilitate the detection and/or analysis of the contents within at least a subset of the microdroplets.

It is commonly known that the electric field is not modulated and the holding and imaging illuminations are present simultaneously, the intensity of the imaging illumination in the non-active state may be kept sufficiently low so as not to interfere with the illumination configured to hold and/or manipulate the microdroplets. However, owing to the weak intensity of the imaging illumination, this may require long image acquisition times, which limit the efficiency of the overall process. Additionally, the microdroplets will drift in the non-active state whilst they are not held by an electric field. Therefore long acquisition periods may be detrimental to maintaining control of the microdroplets within the microfluidic space.

By modulating the electric field between an active and a non-active state and by directly or indirectly controlling the first light source, the apparatus of the present invention can avoid the electric field and the imaging illumination being applied to the microfluidic space simultaneously. This can prevent the light used in acquiring an image of at least a subset of the microdroplets from overpowering the light used for holding at least a subset of the microdroplets and causing unwanted opto-electronic effects, such as oEWOD. Thus, this means that there are no limitations on the imaging illumination wavelength range or intensities that can be utilised when using the apparatus of the present invention. This is in contrast to other techniques for imaging microdroplets in an opto-electronic device, which exclude certain wavelengths and limit the intensity so as not to overpower the illumination for holding the microdroplet. A modulator can be provided to generate a waveform signal to modulate the electric field applied across the microfluidic space. The modulator can be in the active state, in which an electric field is applied across the microfluidic space to enable control of each microdroplet or at least a subset of microdroplets, and in the non-active state, in which the electric field is not applied across the microfluidic space. In the non-active state, the microdroplets are not held by the electric field for a brief period of time. The first modulator can be switched between the active and non-active states at specific time intervals. During the non-active state of the first modulator, images may be taken of at least a subset of microdroplets within the microfluidic space.

To account for the response time of the modulator, the filter, the illumination source, and the transition between the active and non-active states of the modulator not being instantaneous, there may be a period of time between the active and non-active states in which there could be an electric field and there could be no imaging illumination applied to the microdroplets. Through careful synchronisation such that transition times are accounted for, it is possible to minimise or eliminate the impact of these transition time periods.

Another advantage of the present invention is that the modulation between the active and non-active states enables at least a subset of the microdroplets to be recovered to their optimum holding position, even when they have undergone drift during a non-active state. For example, in the non-active state no electric field is applied to the microfluidic space and the microdroplets are not held, therefore, the microdroplets may drift owing to diffusion, Brownian motion, or under the flow of the carrier fluid.

When an imaging illumination is applied to at least a subset of the microdroplets during the active state, the microdroplets can be driven along an illumination gradient which arises owing to non-uniformity in the illumination. Such gradients in the imaging illumination will activate an optoelectrowetting force on the droplets and so hasten the displacement of the droplets from their holding positions.

When no imaging illumination is applied to at least a subset of the microdroplets during the non-active state, for example when taking a chemiluminescence image, the microdroplets may drift passively from their optimum holding position. When the modulator switches the microfluidic device to the active state and the microfluidic space is illuminated with the holding illumination, the microdroplets can move back to their position prior to drifting, provided the modulation takes place within a sufficient time to prevent the microdroplets from drifting beyond the control of the holding illumination.

In some embodiments, a controller can be provided to monitor various parameters, for example, the voltage can be monitored during the experiments and/or the controller can monitor other structures of the apparatus of the present invention such as a filter. The controller may be a computer, a microprocessor or a microcontroller.

In some embodiments, the modulator can switch to an additional state in which there is no electric field applied to the microfluidic space, and there is no illumination of the microdroplet by the light source. In some embodiments, applying a filter to the light source during the non-active state may not be sufficient to enable the optical imaging device to image at least a subset of the microdroplets. In some embodiments it may be necessary for the light source to be put into an ‘off’ state in order to attain an image with the optical imaging device. This can be particularly advantageous for example during chemiluminescence imaging.

In some embodiments, the first modulator can switch between active, non-active and the additional state dynamically, and in any given sequence. For example, the first modulator can, directly and indirectly, control the first light source such that the first light source can be used for oEWOD control of microdroplets in the active state, or for fluorescence imaging of microdroplets in the non-active state, back to oEWOD control of microdroplets in the active state, and then to chemiluminescence imaging of the microdroplets in the additional state.

In some embodiments, the first modulator may be a function generator, or may be a digital switch, or may be an analogue switch.

In some embodiments, the voltage source may be an AC voltage source. In some embodiments, the voltage source may be any voltage source suitable for generating an electric field across the microfluidic space.

In some embodiments, the voltage source may supply a voltage of 1 to 200 V to generate an electric field across the microfluidic space during the active state. In some embodiments, the voltage source may supply a voltage of more than 1, 10, 20, 30, 40, 50, 60, 70, 80, 90, 100, 110, 120, 130, 140, 150, 160, 170, 180 or 190 V during the active state. In some embodiments, the voltage source may supply a voltage of less than 200, 190, 180, 170, 160, 150, 140, 130, 120, 110, 100, 90, 80, 70, 60, 50, 40, 30, 20, or 10 V during the active state. In some embodiments, the voltage source may supply a voltage of 5 to 20V.

In some embodiments, the voltage supplied to the microfluidic space in the non-active state can be less than 1V. In a preferred embodiment, the voltage supplied to the microfluidic space in the non-active state is 0 V.

In some embodiments, the waveform signal generated by the modulator may be a square wave. In some embodiments, any waveform signal with a varying voltage can be generated by the modulator. In some embodiments, a waveform with a fast transition such as a square or top-hat wave is advantageous because it prevents an overlap between the active and non-active states. An overlap can lead to the imaging illumination overpowering the light illumination for holding at least a subset of the microdroplets, which can cause a loss of microdroplet control.

In some embodiments, the microfluidic device may be in the active state, the non-active state and/or an additional state for equal lengths of time.

In some embodiments, the microfluidic device may be in the active state for 90% of a period of time, and may be in the non-active state or the additional state for 10% of the period of time.

In some embodiments, the microfluidic device may be in the active state for 10% of a period of time, and may be in the non-active state or the additional state for 90% of the period of time.

The time spent between the active and non-active or the additional states may be split to achieve a balance between holding and imaging a microdroplet, such that the microdroplets remain sufficiently controlled. The duty cycle between the active and non-active or additional states enables at least a subset of the microdroplets to be recovered to their optimum holding position, even when they have undergone drift. The duty cycle is dependent on the speed at which the microdroplets drift from their optimum holding position. Microdroplets drifting at a higher speed will require a longer active state to regain microdroplet control, whereas microdroplets which drift more slowly may be sufficiently controlled by a duty cycle with a shorter active state.

The speed at which the microdroplets drift depends on multiple factors including, but not limited to, the intensity of the manipulation light source, the length of time the device is in the non-active state for, microdroplet size, microdroplet shape, microdroplet compression and/or viscosity of the carrier phase which the microdroplets are dispersed in. In some embodiments, it is possible to slow down the rate at which microdroplets drift from their optimum position, for example by coating the microfluidic space with a friction coating, cooling the microdroplets, compressing the microdroplets and/or using a more viscous carrier phase.

In some embodiments, a duty cycle with a longer non-active or additional state such as a duty cycle of 10:90 or 1:99, may be preferable when acquiring chemiluminescence images during the non-active or additional state. During the acquisition of a chemiluminescence image, ideally there is no electric field and no imaging illumination applied to the microfluidic space. It may be beneficial to have a longer non-active state or additional state to maximise the time during which a chemiluminescence signal can be detected from at least a subset of the microdroplets. However, because the microdroplets are not held during the non-active state or additional state, they will passively drift from their optimum holding position, and therefore modulating the active and non-active or additional states enables control over the microdroplets to be maintained.

In some embodiments, the waveform signal may have a frequency range of 0.5 to 5000 Hz. In some embodiments, the waveform signal may have a frequency of more than 0.5, 10, 50, 100, 250, 500, 750, 1000, 1250, 1500, 1750, 2000, 2250, 2500, 2750, 3000, 3250, 3500, 3750, 4000, 4250, 4500 or 4750 Hz. In some embodiments, the waveform signal may have a frequency of less than 5000, 4750, 4500, 4250, 4000, 3750, 3500, 3250, 3000, 2750, 2500, 2250, 2000, 1750, 1500, 1250, 1000, 750, 500, 250, 100, 50 or 10 Hz. Preferably, the range is between 4 Hz to 50 Hz.

In some embodiments, the waveform signal modulation frequency can be selected depending on the speed at which the microdroplets drift from their optimum holding position.

In some embodiments, a greater modulation frequency may result in a reduced microdroplet control. In some embodiments, a greater modulation frequency may lead to the illumination of at least a subset of the microdroplets by the illumination source configured to hold and/or manipulate the microdroplets not taking place for a sufficient length of time to maintain microdroplet control.

In some embodiments, a particular modulation frequency may lead to an improved microdroplet control. For example, in an embodiment in which the modulation frequency matches the AC voltage source frequency at 1 KHz, the holding strength at 2.5 KHz modulation frequency may be greater than at 1 KHz modulation frequency.

A minimum modulation frequency depends on the speed at which the microdroplets drift. The device must spend less time in the non-active state or the additional state than the time taken for the microdroplets to drift beyond a position where they can be returned to their optimum holding positions in the active state.

In some embodiments, the microfluidic space may be configured to contain a plurality of microdroplets. The apparatus is suitable for holding and/or manipulating and imaging microdroplets at the single microdroplet level. The apparatus is also suitable for holding and/or manipulating a plurality of microdroplets and imaging at least a sub-set of the plurality of microdroplets.

In some embodiments, at least one microdroplet may comprise a biological entity. In some embodiments, the apparatus may be used to image at least a subset of the microdroplets as part of a biological assay. In some embodiments, the apparatus may be used to perform fluorescence measurements as part of a biological assay.

In some embodiments, the biological entity may be a cell, virus, protein sample, an antibody sample, a functionalised microbead or an enzyme.

In some embodiments, at least one microdroplet may comprise a fluorescent entity. The fluorescent entity may be a fluorescent dye or a fluorescent bead. The fluorescent entity may be attached to a biological entity such as a cell present in the microdroplet. A biological entity such as a cell may be stained with a fluorescent dye.

In some embodiments, a single light source may be used for illuminating at least a subset of the microdroplets during the active state and during the non-active state. In some embodiments, the apparatus may further comprise a second light source. In some embodiments, a first light source can provide the microdroplet holding illumination during the active state, and a second light source can provide an imaging illumination during the non-active state. An apparatus with two light sources is advantageous because it can reduce losses. A single light source may be required to pass through a spatial light modulator, and this has associated losses. This is because a single light source may be required to be filtered using a spatial light modulator, which creates additional unwanted loses. Therefore, using multiple light sources has a higher efficiency.

In some embodiments the imaging during the non-active state may take place in the absence of an illumination source and may detect light emitted by the samples contained within the microdroplets. These embodiments are particularly suitable for imaging samples which are chemiluminescent, phosphorescent or bio-luminescent.

In some embodiments, the apparatus may further comprise a filter for filtering at least a portion of the light from the first and/or second light source.

In some embodiments, a controller is provided and can be configured to control the filter such that the filter permits an imaging illumination provided from the first and/or second light source to be applied across the microfluidic space during the non-active state.

In some embodiments, the apparatus may further comprise a second modulator configured to generate a second waveform signal to modulate the light from the second light source. The second modulator can modulate the light from the second light source such that it is modulated out-of-phase with the first modulator and the modulated electric field, and such that the electric field and imaging illumination are not applied to the microfluidic space simultaneously.

In some embodiments, a second modulator is provided to control a second light source such that the second light source is configured to apply an imaging illumination to at least a subset of the microdroplets during the non-active state. In some embodiments, the first and/or the second modulator may be further configured to control the second light source such that the second light source is configured to apply an imaging illumination to at least a subset of the microdroplets during the non-active state. In some embodiments, the first and/or the second modulator may be further configured to control the second light source such that the second light source provides light suitable for fluorescence to at least a subset of the microdroplets during the non-active state.

In some embodiments in which two light sources are used, the first light source may illuminate at least a subset of the microdroplets continuously in both the active and non-active states. The second light source is configured to apply an imaging illumination to at least a subset of the microdroplets, and is modulated by the second modulator such that the imaging illumination is only applied during the non-active state. For example, the second modulator can modulate the light source and it can switch the light source between an on and an off state. The controller may be configured to modulate or monitor the first and second modulators out-of-phase with each other so that the second light source and the electric field are not active simultaneously and the imaging illumination is prevented from interfering with the manipulation of the microdroplets and causing a loss of droplet control.

In some embodiments, in which two light sources are used, the controller or the first and/or the second modulator may control the filter such that at least a subset of the microdroplets is illuminated at different wavelengths for imaging and holding, and the two illuminations are spectrally distinct. In some embodiments, a filter may be applied to the holding illumination light source such that it does not illuminate the microdroplet during the non-active state and does not interfere with the imaging light illumination.

In some embodiments, the apparatus may further comprise: a first light source configured to provide a light illumination for manipulating at least a subset of the microdroplets; a second light source configured to apply an imaging illumination to at least a subset of the microdroplets; a first modulator configured to generate a first waveform signal to modulate the electric field applied across the microfluidic space; a second modulator configured to generate a second waveform signal to modulate the illumination of at least a subset of the microdroplets with the second light source; and wherein the first modulator is configured to switch between an active state, in which the electric field is applied across the microfluidic space to hold at least a subset of the microdroplets; and an non-active state, in which the electric field is not applied across the microfluidic space; wherein the first or the second modulator is further configured to control, directly or indirectly, the second light source such that the second light source is configured to apply an imaging illumination to at least a subset of the microdroplets during the non-active state.

In some embodiments, the second modulator may be, but is not limited to, a direct electrical modulation through a function generator, a digital switch or an analogue switch, a chopper, an electro-optic modulator, an acousto-optic modulator, or a shutter. In some embodiments, the second modulator can be implemented as a direct LED or laser modulation. In some embodiments, the second modulator can be a spatial light modulator such as a digital micromirror device (DMD), or a liquid crystal spatial light modulator (SLM). In some embodiments, it may be preferable to use an acousto-optic modulator or an electro-optic modulator when the second illumination source is a laser. An acousto-optic modulator is operable over a fixed frequency range and can be used to modulate a fixed wavelength of light. An electro-optic modulator is also operable over a fixed frequency range and may be tuned for each wavelength of light.

In some embodiments, it may be preferable to use a chopper as a second modulator. A chopper is suitable for modulating all wavelengths of light. A chopper can be suited for use in mid-range frequency modulation, for example 100 Hz to 1000 Hz.

In some embodiments, a direct LED or laser modulation may be preferable. A direct LED or laser modulation can be suited for modulation up to the MHz frequency range.

In some embodiments, it may be preferable to use a second modulator that is a shutter. A shutter is suited to attaining well-defined square waves, which are advantageous for preventing any overlap between the electric field applied across the microfluidic space and the imaging illumination of the microdroplet. A shutter is suitable for use with all wavelengths of light. A shutter may have a lower maximum frequency range than other modulators.

In some embodiments, the first and/or second light source may be an LED, or may be a laser, or may be a lamp.

In some embodiments, the laser beam which is used as a light source, may be spatially and temporally coherent. The laser beam can be a collimated beam because the laser beam has high coherence and low divergence. The light provided by the collimated beam of light can be used to illuminate the microfluidic space where microdroplets are positioned. In some embodiments, a laser beam is used to achieve a higher signal to noise ratio than can be achieved with incoherent sources. This can be advantageous when imaging using raster-scanning for example.

In some embodiments, it may be beneficial to use an LED or a lamp as a light source. In a preferred embodiment, a white LED may be used as a light source as it can provide a high power output that can be filtered to selectively apply a narrow wavelength band for fluorescence measurements for example. In some embodiments, a coloured LED may be used as a light source. In some embodiments a lamp such as a xenon lamp may be filtered to achieve a narrow band illumination for optical measurements. An LED may be easier to filter than a lamp.

In some embodiments, the microfluidic device may be in the active state prior to the first modulator switching between the active state and the non-active state. In some embodiments, the microfluidic device may be used for carrying out microdroplet operations prior to taking an image of at least a subset of the microdroplets being required. Therefore the device may be in the active state, with a constant or A/C electric field supplied to the microfluidic space, before the first modulator begins to control the modulation of the electric field applied across the microfluidic space.

In some embodiments, the microfluidic device may be an opto-electrowetting on dielectric (oEWOD) device, or may be an optical tweezer device, or may be an opto-electronic tweezer (OET) device, or may be a dielectrophoresis (DEP) device.

In some embodiments, there is provided a device for manipulating a microdroplet using electrowetting, the device comprising a first composite wall comprising: a first substrate; a first conductor layer on the substrate; and a first continuous dielectric layer on the photoactive layer having a thickness of less than 20 nm; a second composite wall comprising: a second substrate; and a second conductor layer on the substrate.

In some embodiments, the second composite wall optionally comprises a second continuous dielectric layer on the second conductor layer having a thickness of less than 20 nm.

In some embodiments, the first composite wall further comprises a photoactive layer on the first conductor layer.

In some embodiments, the microfluidic device may be an oEWOD device, and the oEWOD structures are comprised of: a first composite wall comprised of a first substrate; a first conductor layer on the substrate, the first conductor layer having a thickness in the range 70 to 250 nm; a photoactive layer activated by electromagnetic radiation in the wavelength range 400-850 nm on the conductor layer, the photoactive layer having a thickness in the range 300-1500 nm and a first dielectric layer on the photoactive layer, the first dielectric layer having a thickness of below 20 nm such as between 1 nm to 20 nm, or it could be in a range of 30 to 160 nm; a second composite wall comprised of: a second substrate; a second conductor layer on the substrate, the second conductor layer having a thickness in the range 70 to 250 nm and optionally a second dielectric layer on the second conductor layer, the second dielectric layer having a thickness of below 20 nm such as between 1 nm to 20 nm, or it could be in the range 30 to 160 nm wherein the exposed surfaces of the composite walls are disposed 20-180 μm apart to define a microfluidic space adapted to contain microdroplets; an A/C source to provide a voltage across the first and second composite walls connecting the first and second conductor layers; first and second sources of electromagnetic radiation having an energy higher than the band gap of the photoactive layer adapted to impinge on the photoactive layer to induce corresponding virtual electrowetting locations on the surface of the first dielectric layer; and means for manipulating the points of impingement of the electromagnetic radiation on the photoactive layer so as to vary the disposition of the virtual electrowetting locations thereby creating at least one electrowetting pathway along which the microdroplets may be caused to move. The first and second walls of these structures are transparent with the microfluidic space sandwiched in-between.

In some embodiments, the first and/or second substrate can be transparent. The first and/or second conductor layer can be transparent.

The A/C source may be configured to provide a voltage of between 0V and 100V across the microfluidic space bounded by the first and second composite walls connecting the first and second conductor layers. In some embodiments, the voltage provided may be between 0V to 50V, or it could be between 0V to 10V. In some embodiments, the A/C source can be configured to provide a voltage of more than 0, 5, 10, 15, 20, 25, 30, 35, 40, 50, 60, 70, 80 or 90 V or it may be less than 90, 80, 70, 60, 50, 45, 40, 35, 30, 25, 20, 15, 10 or 5V.

Suitably, the first and second substrates are made of a material, which is mechanically strong for example glass, silicon, metal or an engineering plastic. In some embodiments, the substrates may have a degree of flexibility. In yet another embodiment, the first and second substrates have a thickness in the range 100-1500 μm, for example 500 μm or 1100 μm. In some embodiments, the first substrate is comprised of one of Silicon, fused silica, and glass. In some embodiments, the second substrate is comprised of one of fused silica and glass.

The first and second conductor layers are located on one surface of the first and second substrates and typically have a thickness in the range 70 to 250 nm, preferably 70 to 150 nm. At least one of these layers is made of a transparent 20 conductive material such as Indium Tin Oxide (ITO), a very thin film of conductive metal such as silver or a conducting polymer such as PEDOT or the like. These layers may be formed as a continuous sheet or a series of discrete structures such as wires. Alternatively, the conductor layer may be a mesh of conductive material with the electromagnetic radiation being directed between the interstices of the mesh.

The photoactive layer is suitably comprised of a semiconductor material which can generate localised areas of charge in response to stimulation by the source of the second electromagnetic radiation. Examples include hydrogenated amorphous silicon layers having a thickness in the range 300 to 1500 nm. In some embodiments, the photoactive layer is activated by the use of visible light. The photoactive layer in the case of the first wall and optionally the conducting layer in the case of the second wall are coated with a dielectric layer which is typically in the thickness range from 30 to 160 nm. The dielectric properties of this layer preferably include a high dielectric strength of >10\hat{ }7 V/m and a dielectric constant of >3. In some embodiments, the dielectric layer is selected from alumina, silica, hafnia or a thin non-conducting polymer film.

In another embodiment of these structures, at least the first dielectric layer, preferably both, are coated with an anti-fouling layer to assist in the establishing the desired microdroplet/carrier fluid/surface contact angle at the various virtual electrowetting electrode locations, and additionally to prevent the contents of the microdroplets adhering to the surface and being diminished as the microdroplet is moved through the chip. If the second wall does not comprise a second dielectric layer, then the second anti-fouling layer may be applied directly onto the second conductor layer.

For optimum performance, the anti-fouling layer should assist in establishing a microdroplet/carrier fluid/surface contact angle that should be in the range 50° to 180° when measured as an air-liquid-surface three-point interface at 25° C. In some embodiments, these layer(s) have a thickness of less than 10 nm and are typically a monomolecular layer. In another, these layers are comprised of a polymer of an acrylate ester such as methyl methacrylate or a derivative thereof substituted with hydrophilic groups; e.g. alkoxysilyl. Either or both of the anti-fouling layers are hydrophobic to ensure optimum performance. In some embodiments, an interstitial layer of silica of thickness less than 20 nm may be interposed between the anti-fouling coating and the dielectric layer in order to provide a chemically compatible bridge.

The first and second dielectric layers, and therefore the first and second walls, define a microfluidic space which is at least 10 μm, and preferably in the range of 20 to 180 μm, in width and in which the microdroplets are contained. Preferably, before they are contained, the microdroplets themselves have an intrinsic diameter which is more than 10% greater, suitably more than 20% greater, than the width of the microfluidic space. Thus, on entering the chip the microdroplets are caused to undergo compression leading to enhanced electrowetting performance through e.g. a better microdroplet merging capability. In some embodiments the first and second dielectric layers can be coated with a hydrophobic coating such a fluorosilane.

In some embodiments, the microfluidic space includes one or more spacers for holding the first and second walls apart by a predetermined amount. Options for spacers include beads or pillars, ridges created from an intermediate resist layer which has been produced by photo-patterning. Alternatively, deposited material such as silicon oxide or silicon nitride may be used to create the spacers. Alternatively layers of film, including flexible plastic films with or without an adhesive coating, can be used to form a spacer layer. Various spacer geometries can be used to form narrow channels, tapered channels or partially enclosed channels which are defined by lines of pillars. By careful design, it is possible to use these spacers to aid in the deformation of the microdroplets, subsequently perform microdroplet splitting and effect operations on the deformed microdroplets. Similarly these spacers can be used to physically separate zones of the chip to prevent cross-contamination between droplet populations, and to promote the flow of droplets in the correct direction when loading the chip under hydraulic pressure. In some embodiments, the spacer can be, but is not limited to, a blade shaped structure, a wedge structure, a pillar, a hydrophilic patch, a narrow channel, or it could be a surface dimple.

The first and second walls are biased using a source of A/C power attached to the conductor layers to provide a voltage potential difference therebetween; suitably in the range 1 to 50 volts. These oEWOD structures are typically employed in association with a source of second electromagnetic radiation having a wavelength in the range 400-850 nm, for example 550, 620 and 660 nm and an energy that exceeds the bandgap of the photoactive layer. Suitably, the photoactive layer will be activated at the virtual electrowetting electrode locations where the incident intensity of the radiation employed is in the range 0.01 to 0.2 Wcm⁻².

Where the sources of electromagnetic radiation are pixelated they are suitably supplied either directly or indirectly using a reflective screen such as a digital micromirror device (DMD) illuminated by light from LEDs or other lamps. This enables highly complex patterns of virtual electrowetting electrode locations to be rapidly created and destroyed on the first dielectric layer thereby enabling the microdroplets to be precisely steered along essentially any virtual pathway using closely-controlled electrowetting forces. Such electrowetting pathways can be viewed as being constructed from a continuum of virtual electrowetting electrode locations on the first dielectric layer.

In some embodiments, the shape of the points of impingement is determined by the shape of the pixilation of the first modulator and/or second modulator. The points of impingement of the sources of electromagnetic radiation on the photoactive layer can be any convenient shape including the conventional circular or annular. In some embodiments, the morphologies of these points are determined by the morphologies of the corresponding pixilation and in another correspond wholly or partially to the morphologies of the microdroplets once they have entered the microfluidic space. In one embodiment, the points of impingement and hence the electrowetting electrode locations may be crescent-shaped and orientated in the intended direction of travel of the microdroplet. Suitably the electrowetting electrode locations themselves are smaller than the microdroplet surface adhering to the first wall and give a maximal field intensity gradient across the contact line formed between the droplet and the surface dielectric.

The first and the second dielectric layers may be composed of a single dielectric material or it may be a composite of two or more dielectric materials. The dielectric layers may be made from, but is not limited to, Al₂O₃ and SiO₂.

A structure may be provided between the first and second dielectric layers. The structure between the first and second dielectric layers can be made of, but is not limited to, epoxy, polymer, silicon or glass, or mixtures or composites thereof, with straight, angled, curved or micro-structured walls/faces. The structure between the first and second dielectric layers may be connected to the top and bottom composite walls to create a sealed microfluidic device and define the channels and regions within the device. The structure may occupy the gap between the two composite walls. Alternatively, or additionally, the conductor and dielectrics may be deposited on a shaped substrate which already has walls.

Some aspects of the methods and apparatus of the present invention are suitable to be applied to an optically-activated device other than an electrowetting device, such as a device configured to manipulate microparticles via dielectrophoresis or optical tweezers. In such a device cells or particles are manipulated and inspected using a functionally identical optical instrument to generate virtual optical dielectrophoresis gradients. Microparticles as defined herein may refer to particles such as biological cells, microbeads made of materials including polystyrene and latex, hydrogels, magnetic microbeads or colloids. Dielectrophoresis and optical tweezer mechanisms are well known in the art and could be readily implemented by the skilled person.

In some embodiments, the optical imaging device further comprises a detector configured to detect an optical signal from at least a subset of the microdroplets. In some embodiments, a detector may be configured to detect a fluorescence signal from the microdroplet. Fluorescence measurements are a crucial tool for performing biological assays. In some embodiments, a detector may be configured to detect a chemiluminescence signal from the microdroplet.

In some embodiments, the detector may further comprise a camera configured to capture an image of at least a subset of the microdroplets. In some embodiments, the detector may comprise a camera which may enable images to be acquired during the non-active state or additional state. In some embodiments, the apparatus can also be used to move microdroplets whilst recording images on the moving microdroplets.

According to an aspect of the present invention, there is provided a species screened by the device, apparatus or method as disclosed herein.

According to an aspect of the present invention, there is provided a species selected by the device, apparatus or method as disclosed herein.

According to an aspect of the present invention, there is provided a species isolated by the device, apparatus or method as disclosed herein.

According to an aspect of the present invention, there is provided a species made by the device, apparatus or method as disclosed herein.

The species may be chemical, biochemical, or biological in nature.

For example, the present invention may provide an agonist/antagonist to an entity as identified by the screening, selection and/or isolation method disclosed herein. The present invention may provide an agonist/antagonist to an entity as identified by the screening, selection and/or isolation method disclosed herein, for use in therapy. The entity may be chemical, biochemical, or biological in nature.

According to an aspect of the present invention, there is provided a use of the device, apparatus, method or species as disclosed herein.

According to an aspect of the present invention, there is provided a use of the device, apparatus, method or species as disclosed herein in therapy.

The present invention may provide for a use of the device, apparatus, method or species as disclosed herein in making a product. The product made may be chemical, biochemical, or biological in nature.

The use may be peptide synthesis. The use may be synthetic biology. The use may be cell line engineering or development. The use may be cell therapy. The use may be drug discovery. The use may be antibody discovery.

According to an aspect of the present invention, there is provided a use of the device, apparatus, method or species as disclosed herein in analysis.

The analysis may be physical, chemical, or biological.

The use may be sub-cellular imaging. The use may be high content imaging.

The use may be diagnostics.

The use may be a biological assay. The biological assay may be high throughput screening. The biological assay may be ELISA.

The use may be cell secretion.

The use may be QC safety profiling.

### FIGURES

The invention will now be further and more particularly described, by way of example only, and with reference to the accompanying drawings, in which:

FIG. 1 shows, schematically, the apparatus of the present invention;

FIG. 2 shows a spatial filter applied across the microfluidic space; and

FIGS. 3A and 3B show two oEWOD configurations according to the present invention.

### DETAILED DESCRIPTION

The present invention herein discloses an apparatus which can be used to maintain control of one or more microdroplets using an opto-electronic droplet manipulation technique, whilst acquiring images and/or taking optical measurements of the one or more microdroplets.

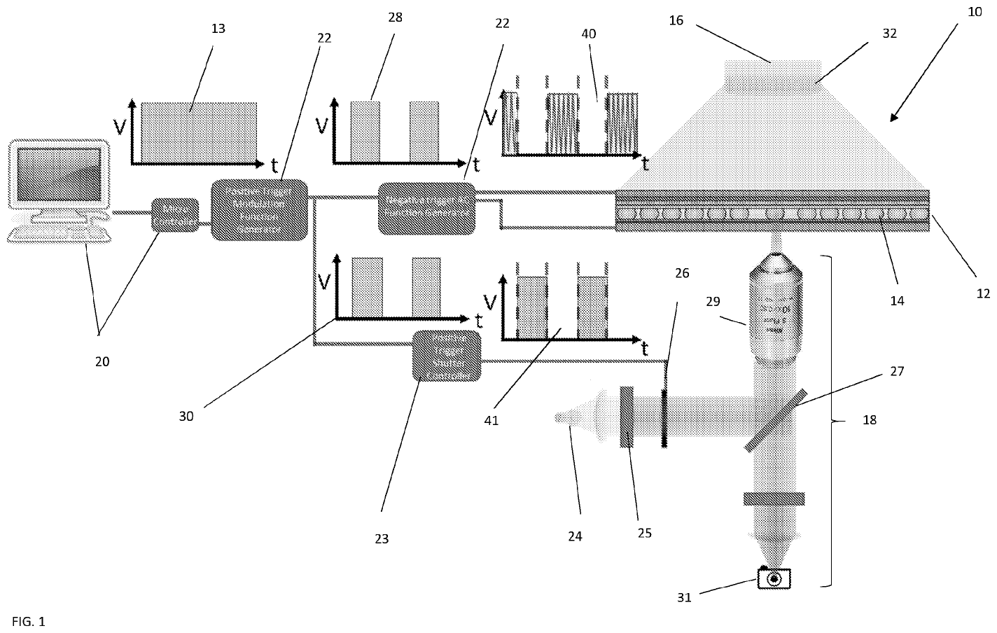

Referring to FIG. 1, there is provided a microfluidic device 10 comprising a microfluidic space 12 configured to contain at least one microdroplet 14, and a light source 16 for illuminating the microfluidic space 12. The microfluidic device 10 may be an opto-electrowetting on dielectric (oEWOD) device, or may be an optical tweezer device, or may be an opto-electronic tweezer (OET) device, or may be a dielectrophoresis (DEP) device.

The microdroplet 14 may comprise a biological entity, such as a cell or an enzyme, and/or a fluorescent entity, such as a fluorescent dye or a fluorescent bead.

The light source 16 may be a halogen lamp, a laser, an LED or any other suitable light source. The light source 16 may be a single colour LED, or preferably a white LED.

A voltage source supplies a voltage to the microfluidic device 10 in order to generate an electric field across the microfluidic space 12. As shown by a graphical representation 13 in FIG. 1, the voltage is applied across the microfluidic space over time. A modulator 22 is configured to generate a waveform signal 28 to modulate the electric field applied across the microfluidic space 12 such that there is an active state, in which the electric field is applied across the microfluidic space 12, and a non-active state, in which the electric field is not applied across the microfluidic space 12. During the active state, the electric field generated across the microfluidic space 12 and the illumination of the microfluidic space by the light source 16 create an opto-electronic force, such as an oEWOD force. The opto-electronic force can be used to control the microdroplets 14 such that they are held in place and/or are manipulated for example merged, split, sorted, and/or arranged into an array.

The modulator 22 may be a function generator, or may be a digital switch, or may be an analogue switch. The waveform signal 28 generated by the modulator 22 may be a square wave or a top-hat wave. The waveform signal 28 may have a frequency range of 0.5 to 5000 Hz. The voltage source may be an A/C voltage source. The voltage source may supply a voltage of 1 to 200 V to generate an electric field across the microfluidic space 12 during the active state. The voltage supplied to the microfluidic space 12 in the non-active state can be less than 1V, and preferably is 0V.

The apparatus also comprises a controller 20 which can be a computer, a microprocessor or a microcontroller. The controller 20 can be configured to control a filter 32, such as a spatial filter. The filter 32 filters at least a portion of the light from the light source 16. The filter 32 may be a colour filter or a spatial filter. The controller 20 may be configured to control a first modulator 22, a second modulator 23, a filter 32 and/or an optical imaging device 18 such that an image of the microdroplet 14 is taken during the non-active state. The filter 32 can be controlled such that it can be used for filtering the light used for holding microdroplets 14, whereby an illumination suitable for imaging is applied to the microdroplets 14 during the non-active state. This can also include the controller 20 controlling the filter 32 such that no imaging illumination is applied to the microdroplets 14 during the non-active state, and an image of the microdroplets 14 is acquired, for example by chemiluminescence.

Additionally, the first modulator 22 can be configured to switch to an additional state in which there is no electric field applied to the microfluidic space 12, and the light source 16 is in an off state. This can be advantageous when carrying out chemiluminescence imaging for example. FIG. 1 also shows that a second modulator 23 can be provided. The second modulator can be configured to, directly or indirectly, control a second light source 24 such that an imaging illumination is provided to at least a subset of the microdroplets.

As shown in FIG. 1, the optical imaging device 18 may further comprise a further filter 25, one or more sets of mirrors 27, one or more lenses 29 for example, an objective lens 29 to focus the light from the second light source 24 onto the microdroplets of interest. The optical imaging device 18 also comprises a detector 31 such as a camera 31 for obtaining an image of the microdroplet, such as a fluorescence image or a chemiluminescence image.

The optical imaging device 18 generates an image of at least a subset of the microdroplets, which may comprise one microdroplet 14. The subset of microdroplets may comprise a plurality of microdroplets. The optical imaging device 18 may include a detector 31. The detector 31 may be configured to detect an optical signal from the microdroplet 14, for example a fluorescence signal or a chemiluminescent signal. The optical imaging device 18 may also comprise a camera which may be used to acquire images of the microdroplets 14. The image can then be processed by a processor.

The apparatus may comprise a single light source 16 which can be used to illuminate at least a subset of the microdroplets 14 during the active and non-active states. As shown in FIG. 1, the apparatus of the present invention may also comprise a second light source 24. When the apparatus comprises two light sources, a first light source 16 can provide the microdroplet holding illumination during the active state, and the second light source 24 can provide an imaging illumination during the non-active state. The second light source 24 may be a lamp, a laser, an LED, or any other suitable light source. The second light source 24 be a single colour LED, or preferably a white LED. The second light source 24 is used to image the microdroplets 14 during the non-active state and may be any light source suitable for fluorescence illumination, fluorescence resonance energy transfer illumination, brightfield illumination, or any other illumination suitable for imaging the microdroplet 14.

When the apparatus comprises a second light source 24, a second modulator 26 is used to modulate the second light source 24. The second modulator 26 can be configured to generate a second waveform signal 30 to modulate the light from the second light source 24. The second modulator 26 can be configured such that it modulates the second light source 24 out-of-phase with the first modulator 22 and the electric field modulation. This results in the electric field and the imaging illumination of the microdroplets 14 not being active simultaneously, and prevents the imaging illumination from interfering with the illumination used for the holding of the microdroplets 14. The second modulator 26 may be, but is not limited to, a direct electrical modulation through a function generator, a digital switch or an analogue switch, a chopper, an electro-optic modulator, an acousto-optic modulator, or a shutter. The second modulator 26 may be a direct LED or laser modulator. The second modulator may be a spatial light modulator such as a digital micromirror device (DMD), or a liquid crystal spatial light modulator (SLM).

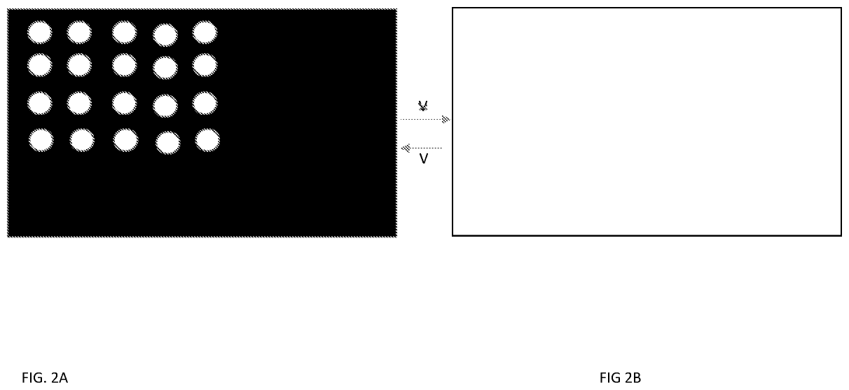

As shown in FIG. 1, a graphical representation shows that the electric field 40 is modulated out of phase to the fluorescence 41. This means that the electric field and the imaging illumination, such as fluorescence illumination, of the microdroplets 14 are not being active simultaneously, and prevents the imaging illumination from interfering with the illumination used for the holding of the microdroplets 14. Referring to FIGS. 2A and 2B, an example of spatial modulation is shown. In some instances, a single light source can be used for holding and imaging at least a subset of microdroplets. In this example, as shown in FIGS. 2A and 2B, a spatial filter is used to pattern the illumination in sync with the applied voltage to create the active and non-active states. The active state comprises of the voltage being applied and having the holding light pattern applied, an example of which is shown in FIG. 2A image. The non-active state would comprised of the applied voltage being disabled and the illumination pattern being switched to blanket illumination, as shown in FIG. 2B where light will illuminate the full field of view when synchronised with a detector this can then be used to generate an image.

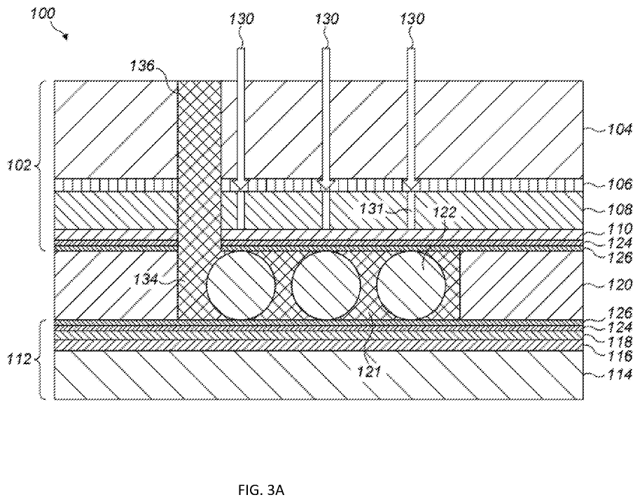

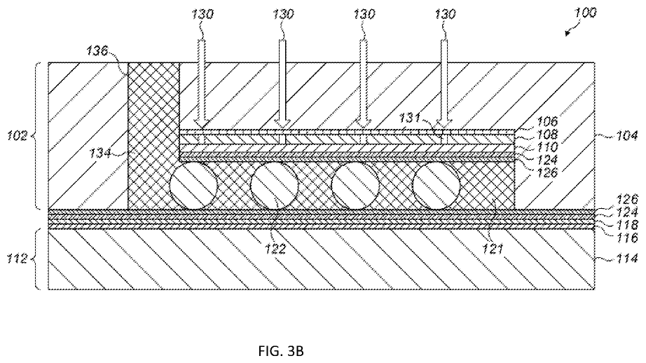

Referring to FIG. 3A, there is provided a microfluidic device and in particular, an oEWOD device 100. The oEWOD device, as illustrated in FIG. 3A, comprises: a first composite wall 102 comprised of a first substrate 104, which can be made out of glass, a first transparent conductor layer 106 on the substrate 104, the first transparent conductor layer 106 having a thickness in the range 70 to 250 nm; a photoactive layer 108 activated by electromagnetic radiation in the wavelength range 400-850 nm on the conductor layer 106, the photoactive layer 108 having a thickness in the range 300-1500 nm and a first dielectric layer 110 on the photoactive layer 108. The first dielectric layer 110 having a thickness of below 20 nm. The lower bound for the thickness of the layer will be dictated, at least in part, by the methodology of providing such a thin layer that must be continuous. However, theoretically it could have a thickness of between 0.1 nm to 20 nm. The first conductor can be transparent.

The device 100 also comprises a second composite wall 112 comprising: a second substrate 114, which can be made out of glass and a second conductor layer 116 on the substrate 114. The second conductor can be transparent. The second conductor layer 116 may have a thickness in the range 70 to 250 nm. A second dielectric layer 118 may be on the second conductor layer 116, where the second dielectric layer 118 has a thickness of below 20 nm such as between 1 nm to 20 nm, or it could be in the range 25 to 160 nm. The exposed surfaces of the composite walls 102, 112 are disposed 20 to 180 μm apart to define a microfluidic space 121 adapted to contain microdroplets 122.

The photoactive layer 108 can be made out of amorphous silicon. The first and second conductors can be made out of ITO.

An interstitial binding layer 124 is provided on the first dielectric layer 110 and can also be provided on the second dielectric layer 118. The thickness of the interstitial layer may be between 0.1 nm to 5 nm. The thickness of the interstitial layer can be more than 0.1, 0.25, 0.5, 0.75, 1, 1.5, 2, 2.5, 3, 3.5, 4 or 4.5 nm, or it may be less than 5 nm, 4.5, 4, 3.5, 3, 2.5, 2, 1.5, 1, 0.75, 0.5 or 0.25 nm. The interstitial layer, for example silicon oxide, is provided on the first and/or the second dielectric layers. The advantage of the interstitial layer is that it can be used as a binding layer for an anti-fouling or non-fouling layer, which may be hydrophobic. In some embodiments, not illustrated in the accompanying drawings, the interstitial binding layer may be omitted. In such embodiments, the hydrophobic layer is applied directly to the dielectric layer.

A hydrophobic layer 126 is provided on the interstitial binding layer 124. An example of a hydrophobic layer could be a fluorosilane or fluorosiloxane. The interstitial binding layers 124 are optional and the channel walls 120 are can be made of SU8, or it may be part of the glass structure. The interstitial layer 124 is provided between the dielectric layer 110, 118 and the hydrophobic layer 126.

An incident light 130, as illustrated in FIG. 3A, can be used to provide a light sprite pattern 131 in which the incident light 130 provides light onto a portion of the microdroplet 122 to hold the microdroplet 122 into a stationary position within the microfluidic space 121. An oil carrier phase 134 can be provided to the microdroplets 122, through a hole 136 in the device, to replenish key nutrients and components to keep the contents within the microdroplet 122, such as one or more cells, alive and healthy. In some cases, the oil phase 134 can provide key nutrients, media and contents for cell growth, viability and/or productivity.

The first and second substrates 104, 114 are made of a material which is mechanically strong for example glass metal or an engineering plastic. In some embodiments, the substrates may have a degree of flexibility. In yet another embodiment, the first and second substrates have a thickness that is at least 100 μm. In some embodiments, the thickness of first and second substrates may be more than 2500 μm, for example 3000, 3500 or 4000 μm. In some embodiments, the first and second substrates can have a thickness in the range of 100 to 2500 μm. In some embodiments, the first and second substrate may have a thickness of more than 100, 200, 300, 400, 500, 600, 700, 800, 900, 1000, 1100, 1200, 1300, 1400, 1500, 1600, 1700, 1800, 1900, 2000, 2100, 2200, 2300 or 2400 μm. In some embodiments, the first and second substrate may have a thickness of less than 2500, 2400, 2300, 2200, 2100, 2000, 1900, 1800, 1700, 1600, 1500, 1400, 1300, 1200, 1100, 1000, 900, 800, 700, 600, 500, 400, 300 or 200 μm. In some embodiments, the first substrate has a thickness of approximately 1100 μm and the second substrate has a thickness of approximately 700 μm. In another embodiment, the first and second substrates have a thickness of 800 microns. In some embodiments, the first substrate is comprised of one of Silicon, fused silica, and glass. In some embodiments, the second substrate is comprised of one of fused silica and/or glass. The glass may be, but is not limited to, a soda lime glass or a float glass.

The first and second conductor layers 106, 116 are located on one surface of the first and second substrates 104, 114 and typically have a thickness in the range 70 to 250 nm, preferably 70 to 150 nm. At least one of these layers is made of a transparent conductive material such as Indium Tin Oxide (ITO), a very thin film of conductive metal such as silver or a conducting polymer such as PEDOT or the like. These layers may be formed as a continuous sheet or a series of discrete structures such as wires. Alternatively, the conductor layer may be a mesh of conductive material with the electromagnetic radiation being directed between the interstices of the mesh.

The photoactive layer 108 is formed from a semiconductor material which can generate localised areas of charge in response to stimulation by the source of the electromagnetic radiation. Examples include hydrogenated amorphous silicon layers having a thickness in the range 300 to 1500 nm. In some embodiments, the photoactive layer is activated by the use of visible light. The photoactive layer is activated by the use of visible light. The dielectric properties of this layer preferably include a high dielectric strength of >10\hat{ }7 V/m and a dielectric constant of >3. In some embodiments, the dielectric layer is selected from alumina, silica, hafnia or a thin non-conducting polymer film.

Alternatively, at least the first dielectric layer, preferably both, may be coated with an anti-fouling layer to assist in the establishing the desired microdroplet/carrier fluid/surface contact angle at the various virtual electrowetting electrode locations. The anti-fouling layer is intended additionally to prevent the contents of the microdroplets adhering to the surface and being diminished as the microdroplet is moved through the chip.

For optimum performance, the anti-fouling layer should assist in establishing a microdroplet/carrier fluid/surface contact angle that should be in the range 50° to 180° when measured as an air-liquid-surface three-point interface at 25° C. In some embodiments, these layer(s) have a thickness of less than 10 nm and are typically a monomolecular layer. Alternatively, these layers are comprised of a polymer of an acrylate ester such as methyl methacrylate or a derivative thereof substituted with hydrophilic groups; e.g. alkoxysilyl. Either or both of the anti-fouling layers are hydrophobic to ensure optimum performance. In some embodiments, an interstitial layer of silica of thickness less than 20 nm may be interposed between the anti-fouling coating and the dielectric layer in order to provide a chemically compatible bridge.

The first and second dielectric layers, and therefore the first and second walls, define a microfluidic space which is at least 10 μm, and preferably in the range of 20 to 180 μm, in width and in which the microdroplets are contained. Preferably, before they are contained, the microdroplets themselves have an intrinsic diameter, which is 10% greater, or 20% greater, than the width of the microdroplet space. Thus, on entering the chip the microdroplets are caused to undergo compression leading to deformation of the spherical microdroplet that leads to enhanced electrowetting performance through e.g. a better microdroplet merging capability. In some instances, the first and second dielectric layers can be coated with a hydrophobic coating such a fluorosilane.

In some embodiments, the microfluidic space includes one or more spacers for holding the first and second walls apart by a predetermined amount. Options for spacers include beads or pillars, ridges created from an intermediate resist layer which has been produced by photo-patterning. Alternatively, deposited material such as silicon oxide or silicon nitride may be used to create the spacers. Alternatively layers of film, including flexible plastic films with or without an adhesive coating, can be used to form a spacer layer. Various spacer geometries can be used to form narrow channels, tapered channels or partially enclosed channels which are defined by lines of pillars. By careful design, it is possible to use these spacers to aid in the deformation of the microdroplets, subsequently perform microdroplet splitting and effect operations on the deformed microdroplets. Similarly these spacers can be used to physically separate zones of the chip to prevent cross-contamination between droplet populations, and to promote the flow of droplets in the correct direction when loading the chip under hydraulic pressure.

The first and second walls are biased using a source of A/C power attached to the conductor layers to provide a voltage potential difference therebetween; suitably in the range 0 to 50 volts. These oEWOD structures are typically employed in association with a source of second electromagnetic radiation having a wavelength in the range 400-850 nm, for example 550 nm, 620 nm and 660 nm and an energy that exceeds the bandgap of the photoactive layer. Suitably, the photoactive layer will be activated at the virtual electrowetting electrode locations where the incident intensity of the radiation employed is in the range 0.005 to 0.1 Wcm⁻². The source of electromagnetic radiation is at a level of 0.005 to 0.1 Wcm⁻², or it could be more than 0.005, 0.0075, 0.01, 0.025, 0.05 or 0.075 Wcm⁻². In some embodiments, the source of electromagnetic radiation is at a level may be less than 0.1, 0.075, 0.05, 0.025, 0.01, 0.0075, 0.005 or 0.0025 Wcm⁻².

Where the sources of electromagnetic radiation are pixelated they are suitably supplied either directly or indirectly using a reflective screen such as a digital micromirror device (DMD) illuminated by light from LEDs or other lamps. This enables highly complex patterns of virtual electrowetting electrode locations to be rapidly created and destroyed on the first dielectric layer thereby enabling the microdroplets to be precisely steered along essentially any virtual pathway using closely-controlled electrowetting forces. Such electrowetting pathways can be viewed as being constructed from a continuum of virtual electrowetting electrode locations on the first dielectric layer.

The first and the second dielectric layers may be composed of a single dielectric material or it may be a composite of two or more dielectric materials. The dielectric layers may be made from, but is not limited to, Al₂O₃ and SiO₂.

A structure may be provided between the first and second dielectric layers. The structure between the first and second dielectric layers can be made of, but is not limited to, epoxy, polymer, silicon or glass, or mixtures or composites thereof, with straight, angled, curved or micro-structured walls/faces. The structure between the first and second dielectric layers may be connected to the top and bottom composite walls to create a sealed microfluidic device and define the channels and regions within the device. The structure may occupy the gap between the two composite walls. Alternatively, or additionally, the conductor and dielectrics may be deposited on a shaped substrate which already has walls.

The oEWOD device 100 as illustrated in FIG. 1B provides an alternative oEWOD configuration. As shown in FIG. 1B, the oEWOD device comprises: a first composite wall 102 comprised of a first substrate 104, which can be made out of glass, a first conductor layer 106 on the substrate 104, the first conductor layer 106 having a thickness in the range 70 to 250 nm; a photoactive layer 108 activated by electromagnetic radiation in the wavelength range 400-850 nm on the conductor layer 106, the photoactive layer 108 having a thickness in the range 300-1500 nm and a first dielectric layer 110 on the photoactive layer 108. The first dielectric layer 110 is formed as a continuous layer that has a thickness of less than 20 nm.

The device 100 as shown in FIG. 1B also comprises a second composite wall 112 comprising: a second substrate 114, which can be made out of glass and a second conductor layer 116 on the substrate 114. The second conductor can be transparent. The second conductor layer 116 may have a thickness in the range 70 to 250 nm. A second dielectric layer 118 may be on the second conductor layer 116, where the second dielectric layer 118 has a thickness of less than 20 nm. As with the first dielectric layer, the second dielectric layer must be continuous and the practical lower bound for the thickness is dictated by manufacturing constraints although it could be between 1 nm to 20 nm. The exposed surfaces of the first 110 and second 118 continuous dielectric layers are disposed 20 to 180 μm apart to define a microfluidic space 121 adapted to contain microdroplets 122.

FIG. 1B shows an alternative embodiment of an oEWOD device 100, in which the spacer layer is not formed from a separate material, but is formed as part of a structure within the first (active) substrate 104. The sub layers of the oEWOD device formed from the first conductor layer 106, the photoactive layer 108, the first dielectric layer 110, interstitial binding layer 124 and hydrophobic layer 126 may partially or completely cover the walls of the spacer structure. A further embodiment is an alternative configuration of the device 100, in which the spacer layer is formed by structuring of the second (passive) substrate 114.

In some cases, the spacer may be formed by structuring both the first and/or second substrates 104, 114, or by using a combination of structures in the first and/or second substrates 104, 114 and an interposing material such as the channel walls 120, as illustrated in FIG. 1A.

An incident light 130, as illustrated in FIG. 1B, can be used to provide a light sprite pattern 131 in which the incident light 130 illuminates a portion of the photoactive layer 108 to hold the microdroplet 122 into a stationary position within the microfluidic space 121. An oil carrier phase 134 can be provided to the microdroplets 122, through a hole 136 in the device, to replenish key nutrients and components to keep the contents within the microdroplet 122, such as one or more cells, alive and healthy. In some cases, the oil phase 134 can provide key nutrients, medium, media and contents for cell growth, viability and/or productivity.

Various further aspects and embodiments of the present invention will be apparent to those skilled in the art in view of the present disclosure.

“and/or” where used herein is to be taken as specific disclosure of each of the two specified features or components with or without the other. For example “A and/or B” is to be taken as specific disclosure of each of (i) A, (ii) B and (iii) A and B, just as if each is set out individually herein.

Unless context dictates otherwise, the descriptions and definitions of the features set out above are not limited to any particular aspect or embodiment of the invention and apply equally to all aspects and embodiments which are described.

It will further be appreciated by those skilled in the art that although the invention has been described by way of example with reference to several embodiments, it is not limited to the disclosed embodiments and that alternative embodiments could be constructed without departing from the scope of the invention as defined in the appended claims.

1-22. (canceled)

23. An apparatus comprising:
a microfluidic device comprising:
a microfluidic space configured to contain a plurality of microdroplets;
a first light source for illuminating the microfluidic device;
a voltage source for supplying a voltage to the microfluidic device in order to generate an electric field across the microfluidic space;
a first modulator provided to generate a waveform signal to modulate the electric field applied across the microfluidic space,
wherein the first modulator is provided to switch between an active state, in which the electric field is applied across the microfluidic space; and a non-active state, in which the electric field is not applied across the microfluidic space; and
wherein the first modulator is further provided to, directly or indirectly, control the first light source such that at least a portion of the light is provided across the microfluidic device during the active state to hold the plurality of microdroplets in the presence of the electric field;
an optical imaging device for generating an image of at least a subset of the microdroplets; and
wherein the first modulator is further configured to control the optical imaging device such that the image of at least a subset of the microdroplets is generated during the non-active state.

24. The apparatus according to claim 23, wherein the first modulator is further configured to control, directly or indirectly, the first light source such that the first light source provides an imaging illumination for imaging at least a subset of microdroplets during the non-active state.

25. The apparatus according to claim 23, wherein the image is a fluorescence image, or a fluorescence resonance energy transfer image, or a brightfield image, or a chemiluminescence image.

26. The apparatus according to claim 23, wherein the waveform signal generated by the first modulator is a square wave.

27. The apparatus according to claim 23, wherein the microfluidic device is in the active state, the non-active state and/or an additional state for equal lengths of time.

28. The apparatus according to claim 23, wherein the microfluidic device is in the active state for 90% of a period of time, and is in the non-active state or the additional state for 10% of the period of time.

29. The apparatus according to claim 23, wherein the microfluidic device is in the active state for 10% of a period of time, and in the non-active state or the additional state for 90% of the period of time.

30. The apparatus according to claim 23, wherein the waveform signal has a frequency range of 0.5 to 5000 Hz.

31. The apparatus according to claim 23, wherein at least one microdroplet comprises a biological entity, wherein the biological entity is a cell, a virus or a protein.

32. The apparatus according to claim 23, wherein at least one microdroplet comprises a fluorescent entity.

33. The apparatus according to claim 23, wherein the modulator is a function generator, or is a digital switch, or is an analogue switch.

34. The apparatus according to claim 23, further comprising a second light source.

35. The apparatus according to claim 34, further comprising a filter for filtering at least a portion of the light from the first and/or second light source.

36. The apparatus according to claim 34, wherein a controller is provided and is configured to control the filter such that the filter permits an imaging illumination provided from the first and/or second light source to be applied across the microfluidic space during the non-active state.

37. The apparatus according to claim 34, further comprising a second modulator configured to generate a second waveform signal to modulate the light from the second light source.

38. The apparatus according to claim 34, wherein the first or second modulator is further configured to control the second light source such that the second light source is configured to apply an imaging illumination to at least a subset of the microdroplets during the non-active state.

39. The apparatus according to claim 23, wherein the microfluidic device is in the active state prior to the first modulator switching between the active state and the non-active state.

40. The apparatus according to claim 23, wherein the microfluidic device is an opto-electrowetting on dielectric (oEWOD) device, or is an optical tweezer device, or is an opto-electronic tweezer (OET) device, or is a dielectrophoresis (DEP) device.

41. The apparatus according to claim 23, wherein the optical imaging device further comprises a detector configured to detect an optical signal from at least a subset of the microdroplets.

42. The apparatus according to claim 23, wherein the first and/or second light source is an LED, or is a laser, or is a lamp.
